(19) United States
(12) Patent Application Publication
(10) Pub. No.: US 2018/0248348 A1
(43) Pub. Date: Aug. 30, 2018

(54) OVERHEAD LINE AND METHOD FOR MANUFACTURING THE SAME, AND METHOD FOR PREVENTING BIRD FROM STRIKING OVERHEAD LINE AT NIGHT

(71) Applicant: FURUKAWA ELECTRIC CO., LTD., Tokyo (JP)

(72) Inventors: Hideki KAMIYAMA, Tokyo (JP); Hiroji AKASAKA, Tokyo (JP)

(73) Assignee: FURUKAWA ELECTRIC CO., LTD., Tokyo (JP)

(21) Appl. No.: 15/968,121

(22) Filed: May 1, 2018

Related U.S. Application Data
(63) Continuation of application No. PCT/JP2017/028485, filed on Aug. 4, 2017.

(30) Foreign Application Priority Data
Aug. 10, 2016 (JP) 2016-157709

(51) Int. Cl. H02G 7/00; A01M 29/08; H01B 9/00; H01B 13/34; H01B 13/26

(52) U.S. Cl. CPC H02G 7/00; A01M 29/08; H01B 13/26; H01B 13/342; H01B 9/008

(57) ABSTRACT

An overhead line (10) including luminous tape (2) wound around the surface of a line body (1) is used to prevent birds from striking the overhead line (10) at night.

### TECHNICAL FIELD

This invention relates to a method for preventing a bird from striking an overhead line (for example, an overhead power transmission line or an overhead ground wire) at night.

### BACKGROUND ART

About 40% of accidents (bird strike accidents) in which birds, such as migratory birds, hit overhead lines happen at night. Regarding measures against bird strike accidents occurring at night, a method for coating the surface of a spiral rod with luminous paint (PTL 1) and a method for attaching luminous line rings to an overhead power transmission line (PTL 2) have been proposed.

PTL 3 discloses water-repellent, heat-resistant resin tape wounded around an overhead line to prevent snow from accreting to the overhead line.

### CITATION LIST

### Patent Literature

PTL 1: JP H11-168822 A

PTL 2: JP 2007-14103 A

PTL 3: JP 2005-117841 A

### SUMMARY OF INVENTION

### Technical Problem

The methods for preventing a bird from striking an overhead line at night, disclosed in PTLs 1 and 2, pose the following problems. In the method disclosed in PTL 1, the coating and drying processes are laborious and the effects easily deteriorate due, for example, to aging of the coating. In the method disclosed in PTL 2, the use of a large number of rings to apply continuous effects in the longitudinal direction of the overhead line leads to a heavier weight and a higher wind load, and this may adversely affect the pylon strength.

It is a problem underlying this invention to provide a method which involves less labor and less increase in weight of an overhead line than the conventional methods, as a measure against bird strike accidents at night for the overhead line.

### Solution to Problem

To solve the above-described problem, the first aspect of this invention provides an overhead line including a line body, and luminous tape wound around a surface of the line body.

The second aspect of this invention provides a method for manufacturing an overhead line, the method including a first step of spirally winding luminous tape around a surface of a line body with a spacing, and a second step of spirally winding transparent protective tape around the surface of the line body, after the first step, with a spacing to include an overlap with the luminous tape in a direction identical to a direction in which the luminous tape is wound.

The third aspect of this invention provides a method for manufacturing an overhead line, the method including a first step of spirally winding luminous tape around a surface of a line body with a spacing, and a second step of spirally winding transparent protective tape around the surface of the line body, after the first step, with a spacing in a direction opposite to a direction in which the luminous tape is wound.

The fourth aspect of this invention provides a method for preventing a bird from striking an overhead line at night, the method including using the overhead line according to the first aspect to prevent the bird from striking the overhead line at night.

### Advantageous Effects of Invention

A method for preventing a bird from striking an overhead line at night in one aspect of this invention involves less labor and less increase in weight of the overhead line than the conventional methods.

### BRIEF DESCRIPTION OF DRAWINGS

FIG. 1 is a side view illustrating an overhead power transmission line according to a first embodiment;

FIG. 2 is a side view of a power transmission line body for explaining a first step for obtaining overhead power transmission lines according to the first, second, and fourth embodiments;

FIG. 3 is a side view illustrating the overhead power transmission line according to the second embodiment;

FIG. 4 is a side view illustrating an overhead power transmission line according to a third embodiment;

FIG. 5 is a side view of a power transmission line body for explaining a pre-process for obtaining an overhead power transmission line according to the third embodiment;

FIG. 6 is a side view of the power transmission line body for explaining a first step for obtaining an overhead power transmission line according to the third embodiment; and

FIG. 7 is a side view illustrating the overhead power transmission line according to the fourth embodiment.

### DESCRIPTION OF EMBODIMENTS

While embodiments of this invention will be described below, this invention is not limited to the following embodiments. In the following embodiments, technically preferable limitations are imposed to carry out this invention, but these limitations are not indispensable for this invention.

### First Embodiment

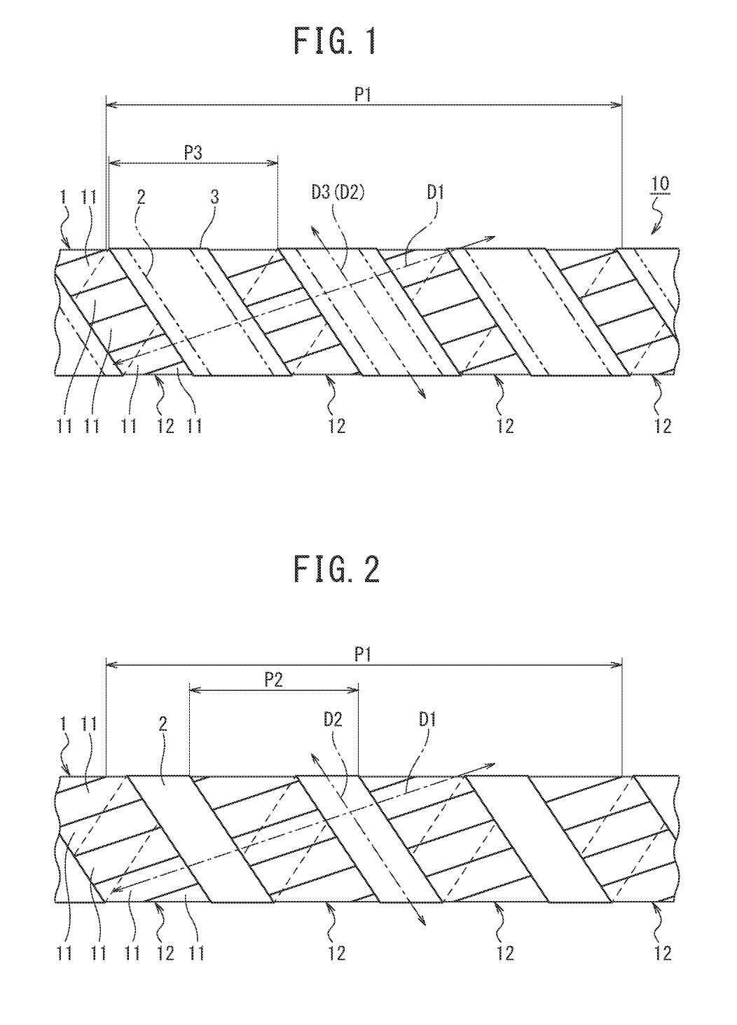

An overhead power transmission line (overhead line) 10 according to a first embodiment includes a power transmission line body (line body) 1, luminous tape 2, and transparent protective tape 3, as illustrated in FIG. 1. The outermost layer of the power transmission line body 1 is made of a twisted wire formed by twisting five (a plurality of) wires 11. The luminous tape 2 is spirally wound around the surface of the power transmission line body 1 with spacings.

The transparent protective tape 3 is larger in width than the luminous tape 2 and covers the entire surface (upper surface) of the luminous tape 2 and the two end faces of the luminous tape 2 throughout the length of the luminous tape 2. Exposed portions 12 of the power transmission line body 1 are present between lines of the transparent protective tape 3 adjacent in the longitudinal direction of the power transmission line body 1. In other words, a plurality of portions in the longitudinal direction of the power transmission line body 1 are exposed.

An overhead power transmission line 10 according to the first embodiment can be obtained by the following method.

First, as a first step, luminous tape 2 is spirally wound around the surface of a power transmission line body 1 with spacings in the longitudinal direction of the power transmission line body 1, as illustrated in FIG. 2. Thus, exposed portions 12 of the power transmission line body 1 occur between lines of the luminous tape 2 adjacent in the longitudinal direction of the power transmission line body 1. The direction (spiral direction) D2 in which the luminous tape 2 is wound is set opposite to the direction (spiral direction) D1 in which the outermost layer of a twisted wire is twisted. The winding pitch P2 of the luminous tape 2 is set in the range of 0.1 times (inclusive) to 0.5 times (inclusive) the twist pitch P1 of the outermost layer of a twisted wire forming the power transmission line body 1.

Then, as a second step, transparent protective tape 3 larger in width than the luminous tape 2 is spirally wound around the surface of the power transmission line body 1, after the first step, to be overlaid on the luminous tape 2 to match their widthwise centers with each other, as illustrated in FIG. 1. In other words, the direction D2 in which the luminous tape 2 is wound is set identical to the direction D3 in which the transparent protective tape 3 is wound, and the winding pitch P3 of the transparent protective tape 3 is set equal to the winding pitch P2 of the luminous tape 2.

The first and second steps can be executed using a tape winder employed to wind snow accretion-resistant tape around the overhead power transmission line. The tape winder includes a movable body (main body) including a central hole to insert an overhead power transmission line, and a tape holder which holds tape to be fed.

With the overhead power transmission line 10 according to the first embodiment, since the luminous tape 2 is wound around the power transmission line body 1, birds can perceive the overhead power transmission line 10 at night. This can prevent birds from striking the overhead power transmission line 10 at night.

In other words, the overhead power transmission line 10 according to the first embodiment employs a method for winding the luminous tape 2 around the overhead power transmission line 10 to prevent birds from striking the overhead power transmission line 10 at night. This method for preventing a bird from striking the overhead power transmission line 10 at night involves less labor and less increase in weight of the overhead power transmission line 10 than the conventional methods.

Since the transparent protective tape 3 is overlaid on the luminous tape 2 and wound in the same direction to cover the two end faces of the luminous tape 2, water can hardly enter the two widthwise ends of the luminous tape 2. This makes it hard for the luminous tape 2 to deteriorate and to peel off the power transmission line body 1.

The presence of the exposed portions 12 in the power transmission line body 1 can prevent moisture from collecting on the power transmission line body 1 to inhibit corrosion of the power transmission line body 1. In addition, since the direction D2 in which the luminous tape 2 is wound is opposite to the direction D1 in which the outermost layer of a twisted wire forming the power transmission line body 1 is twisted, the end faces of the luminous tape 2 receive snow accretions moving in the direction D1 of twist. This can inhibit any snow accretion from developing circumferentially.

Since the winding pitch P2 of the luminous tape 2 is set in the range of 0.1 times (inclusive) to 0.5 times (inclusive) the twist pitch P1 of the outermost layer of a twisted wire forming the power transmission line body 1, a snow accretion resistance effect can be obtained while keeping the material and construction costs. When P2 is lower than 0.1 times of P1, unnecessarily long tape is wound and the material cost is comparatively high, and the winding time is long and the construction cost is also comparatively high. When P2 is higher than 0.5 times of P1, no satisfactory snow accretion resistance effect can be attained.

In other words, preferably, the twist pitch P1 of the outermost layer of the twisted wire and the winding pitch P2 of the luminous tape 2 satisfy relation (1), and the twist pitch P1 of the outermost layer of the twisted wire and the winding pitch P3 of the transparent protective tape 3 satisfy relation (2):

0.1P1≤P2≤0.5P1 (1)

0.1P1≤P3≤0.5P1 (2)

### Second Embodiment

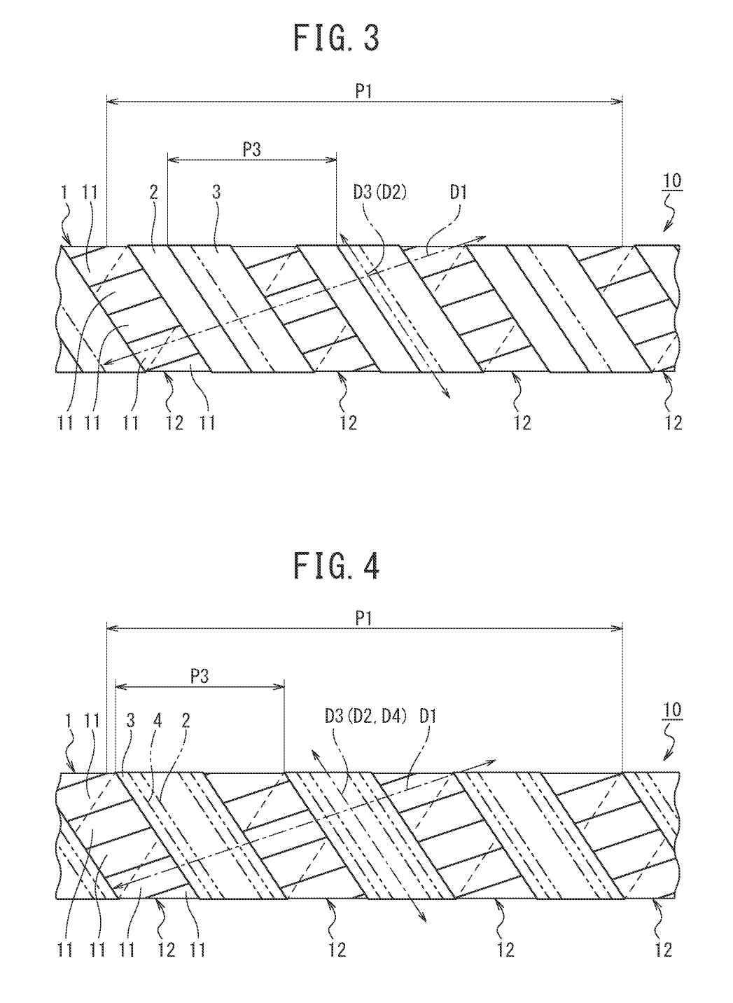

An overhead power transmission line (overhead line) 10 according to a second embodiment includes a power transmission line body (line body) 1, luminous tape 2, and transparent protective tape 3, as illustrated in FIG. 3. The outermost layer of the power transmission line body 1 is made of a twisted wire formed by twisting five (a plurality of) wires 11. The luminous tape 2 is spirally wound around the surface of the power transmission line body 1 with spacings.

The transparent protective tape 3 is equal in width to the luminous tape 2. Apart (one widthwise end) of the surface (upper surface) of the luminous tape 2 and one widthwise end face of the luminous tape 2 are covered with the transparent protective tape 3 throughout the length of the luminous tape 2.

Exposed portions 12 of the power transmission line body 1 are present between lines of the luminous tape 2 and the transparent protective tape 3 adjacent in the longitudinal direction of the power transmission line body 1. In other words, a plurality of portions in the longitudinal direction of the power transmission line body 1 are exposed.

An overhead power transmission line 10 according to the second embodiment can be obtained by the following method.

First, a first step is executed by the same method as in the first embodiment to set a state illustrated in FIG. 2.

Then, as a second step, transparent protective tape 3 equal in width to the luminous tape 2 is spirally wound around the surface of the power transmission line body 1, after the first step, to be overlaid on one widthwise end of the luminous tape 2, as illustrated in FIG. 3. The direction D2 in which the luminous tape 2 is wound is set identical to the direction D3 in which the transparent protective tape 3 is wound, and the winding pitch P3 of the transparent protective tape 3 is set equal to the winding pitch P2 of the luminous tape 2.

With the overhead power transmission line 10 according to the second embodiment, the same effect of preventing birds from striking the overhead power transmission line 10 at night as in the overhead power transmission line 10 of the first embodiment can be obtained. However, the durability of the luminous tape 2 is higher in the overhead power transmission line 10 of the first embodiment. This is because the entire surface and widthwise end faces of the luminous tape 2 are covered with the transparent protective tape 3 in the first embodiment, while only one widthwise end of the luminous tape 2 is covered with the transparent protective tape 3 in the second embodiment. Nevertheless, since this one end is on the side on which water enters along the wires 11 of the power transmission line body 1, the effect of preventing water entrance from this side is greater than in the overhead power transmission line 10 of the first embodiment.

### Third Embodiment

An overhead power transmission line (overhead line) 10 according to a third embodiment includes a power transmission line body (line body) 1, luminous tape 2, transparent protective tape 3, and base tape 4, as illustrated in FIG. 4. The outermost layer of the power transmission line body 1 is made of a twisted wire formed by twisting five (a plurality of) wires 11.

The luminous tape 2 is spirally wound around the surface of the power transmission line body 1 with spacings via the base tape 4. The base tape 4 has a width larger than that of the luminous tape 2 and smaller than that of the transparent protective tape 3. The entire surface (upper surface) of the luminous tape 2, the base tape 4, and the widthwise end faces of the luminous tape 2 are covered with the transparent protective tape 3 throughout the length of the luminous tape 2.

Exposed portions 12 of the power transmission line body 1 are present between lines of the transparent protective tape 3 adjacent in the longitudinal direction of the power transmission line body 1. In other words, a plurality of portions in the longitudinal direction of the power transmission line body 1 are exposed.

An overhead power transmission line 10 according to the third embodiment can be obtained by the following method.

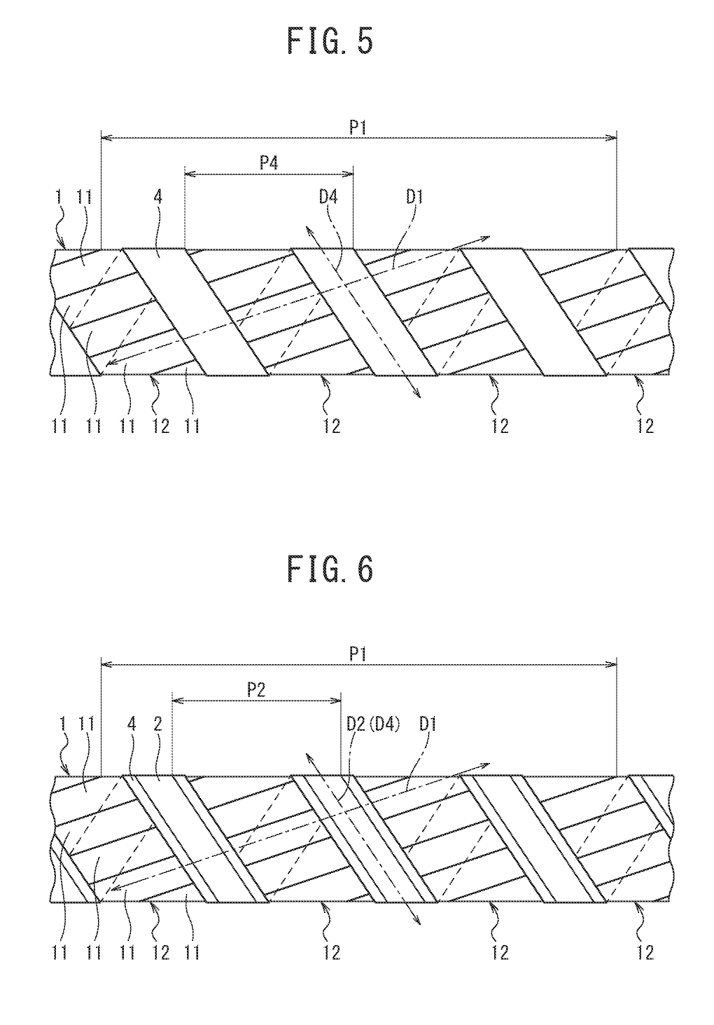

First, as a pre-process, base tape 4 is spirally wound around the surface of a power transmission line body 1 with spacings in the longitudinal direction of the power transmission line body 1, as illustrated in FIG. 5. Thus, exposed portions 12 of the power transmission line body 1 occur between lines of the base tape 4 adjacent in the longitudinal direction of the power transmission line body 1. The direction D4 in which the base tape 4 is wound is set opposite to the direction D1 in which the outermost layer of a twisted wire is twisted. The winding pitch P4 of the base tape 4 is set in the range of 0.1 times (inclusive) to 0.5 times (inclusive) the twist pitch P1 of the outermost layer of a twisted wire forming the power transmission line body 1.

Then, as a first step, luminous tape 2 smaller in width than the base tape 4 is spirally wound around the surface of the power transmission line body 1, after the pre-process, to be overlaid on the base tape 4 to match their widthwise centers with each other, as illustrated in FIG. 6. In other words, a first step is executed without allowing the luminous tape 2 to extend off the base tape 4, the direction D4 in which the base tape 4 is wound is set identical to the direction D2 in which the luminous tape 2 is wound, and the winding pitch P2 of the luminous tape 2 is set equal to the winding pitch P4 of the base tape 4.

Then, as a second step, transparent protective tape 3 larger in width than the base tape 4 is spirally wound around the surface of the power transmission line body 1, after the first step, with spacings to be overlaid on the luminous tape 2 to match their widthwise centers with each other, as illustrated in FIG. 4. In other words, a second step is executed without allowing the base tape 4 to extend off the transparent protective tape 3, the direction D2 in which the luminous tape 2 is wound is set identical to the direction D3 in which the transparent protective tape 3 is wound, and the winding pitch P3 of the transparent protective tape 3 is set equal to the winding pitch P2 of the luminous tape 2.

A pre-process can also be executed using a tape winder employed to wind snow accretion-resistant tape around the overhead power transmission line, as in the first and second steps.

With the overhead power transmission line 10 according to the third embodiment, the same effect of preventing birds from striking the overhead power transmission line 10 at night as in the overhead power transmission line 10 of the first embodiment can be obtained. Further, since the base tape 4 is wound between the luminous tape 2 and the power transmission line body 1, the effect of preventing water entrance to the luminous tape 2 is greater than in the overhead power transmission line 10 of the first embodiment.

### Fourth Embodiment

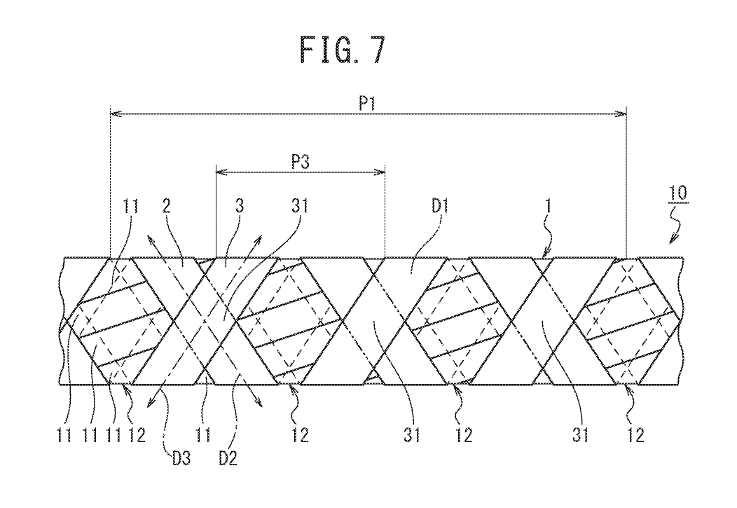

An overhead power transmission line (overhead line) 10 according to a fourth embodiment includes a power transmission line body (line body) 1, luminous tape 2, and transparent protective tape 3, as illustrated in FIG. 7. The outermost layer of the power transmission line body 1 is made of a twisted wire formed by twisting five (a plurality of) wires 11. The luminous tape 2 is spirally wound around the surface of the power transmission line body 1 with spacings.

The transparent protective tape 3 is equal in width to the luminous tape 2. The surface (upper surface) and the widthwise end faces of the luminous tape 2 are covered with the transparent protective tape 3 in a plurality of portions in the longitudinal direction of the luminous tape 2. In other words, the transparent protective tape 3 includes a plurality of portions 31 in the longitudinal direction, covering the surface (upper surface) of the luminous tape 2.

Exposed portions 12 of the power transmission line body 1 are present between lines of the transparent protective tape 3 adjacent in the longitudinal direction of the power transmission line body 1. In other words, a plurality of portions in the longitudinal direction of the power transmission line body 1 are exposed.

An overhead power transmission line 10 according to the fourth embodiment can be obtained by the following method.

First, a first step is executed by the same method as in the first embodiment to set a state illustrated in FIG. 2.

Then, as a second step, transparent protective tape 3 equal in width to the luminous tape 2 is spirally wound around the surface of the power transmission line body 1, after the first step, with spacings in a direction D3 of winding opposite to the direction D2 in which the luminous tape 2 is wound, as illustrated in FIG. 7. The winding pitch P3 of the transparent protective tape 3 is set equal to the winding pitch P2 of the luminous tape 2.

With the overhead power transmission line 10 according to the fourth embodiment, the same effect of preventing birds from striking the overhead power transmission line 10 at night as in the overhead power transmission line 10 of the first embodiment can be obtained. However, the durability of the luminous tape 2 is higher in the overhead power transmission line 10 of the first embodiment. This is because the entire surface and widthwise end faces of the luminous tape 2 are covered with the transparent protective tape 3 in the first embodiment, while only parts in the longitudinal direction of the luminous tape 2 are covered with the transparent protective tape 3 in the fourth embodiment.

The transparent protective tape 3 is wound to intersect the luminous tape 2 to support, when the luminous tape 2 is cut, a portion close to the cut, and thus can prevent the luminous tape 2 from considerably drooping.

[Luminous Tape, Transparent Protective Tape, and Base Tape]

The luminous tape 2 exhibits the light storage performance and can be easily wound around the line body 1 when luminous tape including an adhesive layer formed on its lower surface is used.

The transparent protective tape 3 exhibits a transparency that does not disturb the light storage performance of the luminous tape 2, and can be easily wound around the line body 1 when transparent protective tape including an adhesive layer formed on its lower surface is used.

The base tape 4 may be either transparent or tinted and can be easily wound around the line body 1 when base tape including an adhesive layer formed on its lower surface is used. In addition, when base tape 4 including an adhesive layer formed on its upper surface is used, luminous tape 2 including no adhesive layer formed on its lower surface can be easily wound on the base tape 4.

The luminous tape 2, the transparent protective tape 3, and the base tape 4 are commercially available as products. More specifically, a “High-luminance LumiNova Film” available from Nemoto Lumi-Materials Co., Ltd. may be used as the luminous tape 2, a “Smart Seal” available from 3M Japan Limited may be used as the transparent protective tape 3, and a “Smart Seal” available from 3M Japan Limited may be used as the base tape 4.

[Others]

In each of the above-described embodiments, the luminous tape 2 and the transparent protective tape 3 are separately wound around the power transmission line body 1. However, an effect of preventing birds from striking an overhead line at night can be obtained even when integrated tape (that is, luminous tape including a transparent protective layer) including transparent protective tape 3 adhering onto luminous tape 2 is wound around the power transmission line body 1.

This invention is applied to an overhead power transmission line in each of the above-described embodiments, but is also applicable to overhead lines (for example, overhead ground wires) other than such overhead power transmission lines.

### REFERENCE SIGNS LIST

1 . . . power transmission line body (line body)
10 . . . overhead power transmission line (overhead line)
11 . . . wire
12 . . . exposed portion
2 . . . luminous tape
3 . . . transparent protective tape
31 . . . portion covering surface (upper surface) of luminous tape
4 . . . base tape

1. An overhead line comprising:
a line body; and
luminous tape wound around a surface of the line body.

2. The overhead line according to claim 1, further comprising:
transparent protective tape,
wherein an upper surface and a widthwise end face of the luminous tape are covered with the transparent protective tape throughout a length of the luminous tape, and
a plurality of portions in a longitudinal direction of the line body are exposed.

3. The overhead line according to claim 2, further comprising:
base tape placed between the luminous tape and the line body,
wherein the base tape has a width larger than a width of the luminous tape and smaller than a width of the transparent protective tape, and
the base tape and the widthwise end face of the luminous tape are covered with the transparent protective tape.

4. The overhead line according to claim 1, further comprising:
transparent protective tape,
wherein an upper surface and a widthwise end face of the luminous tape are covered with the transparent protective tape in a plurality of portions in a longitudinal direction of the luminous tape, and
a plurality of portions in a longitudinal direction of the line body are exposed.

5. The overhead line according to claim 1, wherein the line body comprises a twisted wire, and a direction in which the luminous tape is wound is opposite to a direction in which an outermost layer of the twisted wire is twisted.

6. A method for manufacturing an overhead line, the method comprising:
a first step of spirally winding luminous tape around a surface of a line body with a spacing; and
a second step of spirally winding transparent protective tape around the surface of the line body, after the first step, with a spacing to include an overlap with the luminous tape in a direction identical to a direction in which the luminous tape is wound.

7. The method for manufacturing an overhead line according to claim 6, wherein
before the first step, a pre-process is executed in which base tape having a width larger than a width of the luminous tape and smaller than a width of the transparent protective tape is spirally wound around the surface of the line body with a spacing,
the first step is executed without allowing the luminous tape to extend off the base tape, and
the second step is executed without allowing the base tape to extend off the transparent protective tape.

8. A method for manufacturing an overhead line, the method comprising:
a first step of spirally winding luminous tape around a surface of a line body with a spacing; and
a second step of spirally winding transparent protective tape around the surface of the line body, after the first step, with a spacing in a direction opposite to a direction in which the luminous tape is wound.

9. The method for manufacturing an overhead line according to claim 6, wherein the line body comprises a twisted wire, and a direction in which the luminous tape is wound is set opposite to a direction in which an outermost layer of the twisted wire is twisted.

10. A method for preventing a bird from striking an overhead line at night, the method comprising: using the overhead line according to claim 1 to prevent the bird from striking the overhead line at night.

11. The method for manufacturing an overhead line according to claim 7, wherein the line body comprises a twisted wire, and a direction in which the luminous tape is wound is set opposite to a direction in which an outermost layer of the twisted wire is twisted.

12. The method for manufacturing an overhead line according to claim 8, wherein the line body comprises a twisted wire, and a direction in which the luminous tape is wound is set opposite to a direction in which an outermost layer of the twisted wire is twisted.

13. A method for preventing a bird from striking an overhead line at night, the method comprising: using the overhead line according to claim 2 to prevent the bird from striking the overhead line at night.

14. A method for preventing a bird from striking an overhead line at night, the method comprising: using the overhead line according to claim 3 to prevent the bird from striking the overhead line at night.

15. A method for preventing a bird from striking an overhead line at night, the method comprising: using the overhead line according to claim 4 to prevent the bird from striking the overhead line at night.

16. A method for preventing a bird from striking an overhead line at night, the method comprising: using the overhead line according to claim 5 to prevent the bird from striking the overhead line at night.
